(19) United States
(12) Patent Application Publication
(10) Pub. No.: US 2005/0205547 A1
(43) Pub. Date: Sep. 22, 2005

(54) Conveyor oven

(75) Inventor: Gerhard H. Wenzel, Sussex, WI (US)

Correspondence Address: FOLEY & LARDNER, 777 EAST WISCONSIN AVENUE, SUITE 3800, MILWAUKEE, WI, 53202-5308, US

(73) Assignee: Hatco Corporation

(21) Appl. No.: 10/806,074

(22) Filed: Mar. 22, 2004

(51) Int. Cl. F27D 11/00

(52) U.S. Cl. 219/388

(57) ABSTRACT

A conveyor oven is described herein which includes a heating chamber which receives a food item to be heated, a conveyor which moves the food item through the heating chamber using indexed movement, and a motor which is used to drive the conveyor.

### BACKGROUND

Conveyor ovens are typically used in applications which require a relatively large amount of food to be cooked at a constant temperature and for a constant amount of time. Conventional conveyor ovens utilize a continually operating conveyor upon which food may be placed to be transported through the oven. As the food is transported through the oven, the food is heated and/or cooked the desired amount. The use of a conveyor in combination with an oven provides greater efficiency and effectiveness in heating and/or cooking the food products.

Unfortunately, conventional conveyor ovens often suffer from a number of drawbacks. For example, in many conventional conveyor ovens it is often difficult to adjust the operating conditions in a timely manner in order to process a variety of food products. Thus, a conventional conveyor oven is, in effect, used to heat the same type of food product. Therefore, if a user desires to heat a variety of food products then multiple conveyor ovens each being configured at the desired conditions are typically required. However, this solution is often undesirable due to the large size and expense associated with multiple conveyor ovens. The problem is even more acute in situations where there are a large number of food products and limited space (e.g., fast food restaurant, convenience store, etc.).

Also, a typical conveyor oven remains on during a period when it may be required to be used (e.g., business hours, work shift, etc.) even though there may be no food products being cooked for a substantial amount of time during the period. The conveyor oven remains on during the entire period because it takes a substantial amount of time to warm up the conveyor oven making it impractical to turn the oven off when food is not being heated. In addition to warming up from an off state, typical conveyor ovens also take a substantial amount of time to transition from one operating condition (e.g., temperature, etc.) required by one product to another operating condition required by another product. In some situations, it may be desirable to rapidly modify the oven's temperature or other operating parameters so that different food products may be prepared without a substantial setup time between products. For example, where a conveyor oven is used in a convenience store application or other application to cook several types or sizes of food products for immediate service to a retail customer, it may be desirable that the oven's operating parameters may be changed to accommodate the next product after the oven has finished cooking the previous product.

Accordingly, it would be desirable to provide an improved conveyor oven that reduce these problems as well as other problems associated with conventional conveyor ovens. It should be understood, however, that the claims define the scope of the subject matter for which protection is sought, regardless of whether any of the aforementioned disadvantages are overcome by the subject matter recited in the claims. Also, the terms recited in the claims should be given their ordinary and customary meaning as would be recognized by those of skill in the art, except, to the extent a term is used herein in a manner more expansive than its ordinary and customary meaning, the term should be given its ordinary and customary meaning plus the additional expansive meaning, or except if a term has been explicitly defined to have a different meaning by reciting the term followed by the phase “as used herein shall mean” or similar language. Accordingly, the claims are not tied and should not be interpreted to be tied to any particular embodiment, feature, or combination of features other than those explicitly recited in the claims. Thus, the appended claims should be read to be given their broadest interpretation in view of the prior art and the ordinary meaning of the claim terms.

### DRAWINGS

FIG. 1 is a perspective view of one embodiment of a conveyor oven.

FIG. 2 is a partially exploded front perspective view of the conveyor oven of FIG. 1.

FIG. 3 is a front side view of the conveyor oven of FIG. 1.

FIG. 4 is a front side view of the conveyor oven of FIG. 1 showing a conveyor belt.

FIG. 5 is a right side view of the conveyor oven of FIG. 1.

FIG. 6 is a left side view of the conveyor oven of FIG. 1.

FIG. 7 is a top side view of the conveyor oven of FIG. 1.

### DETAILED DESCRIPTION

Although the subject matter described herein is provided in the context of a conveyor oven, it should be understood that the concepts and features described may be used in a variety of settings and situations as would be recognized by those of ordinary skill in the art. The term “oven” as used herein should not be limited to those devices which cook food. Rather, “oven” is used to refer to any device which uses elevated temperatures to heat, brown, cook, finish, bake, broil, toast, warm, etc., various food items. Also, it should be understood, that the features, advantages, characteristics, etc. of one embodiment may be applied to and/or combined with any other embodiment or embodiments to form an additional embodiment unless noted otherwise.

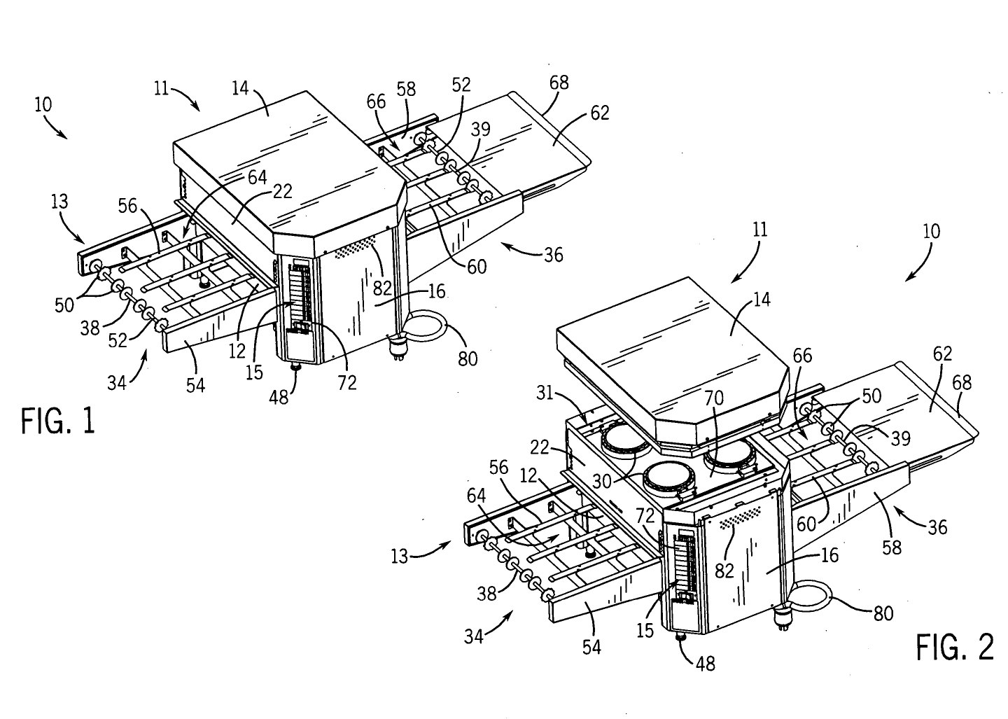

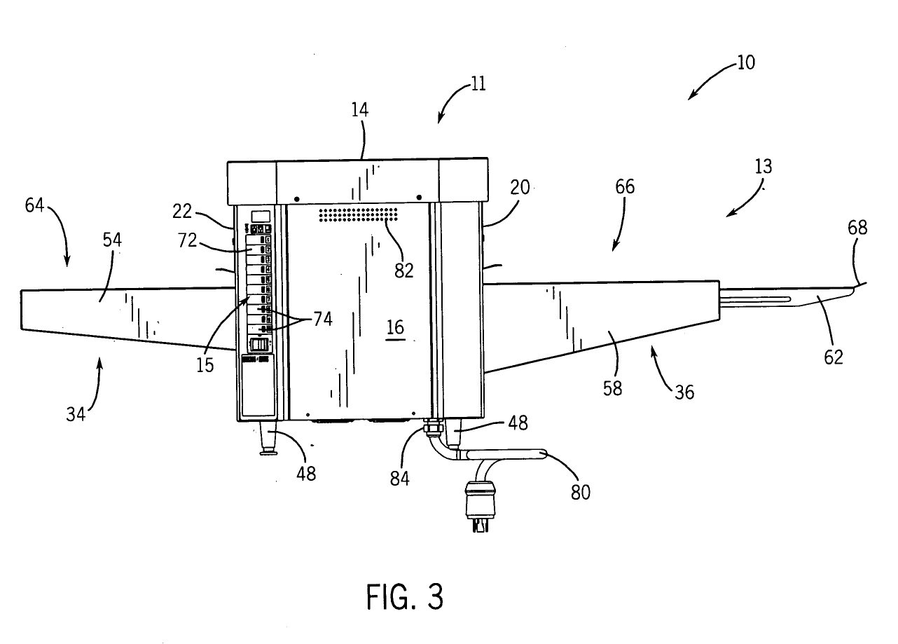

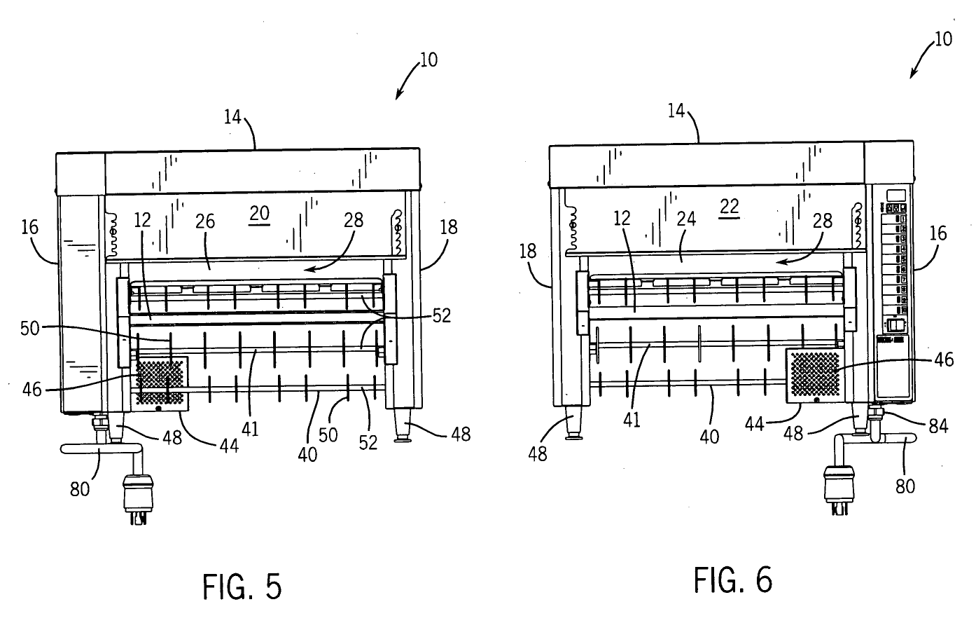

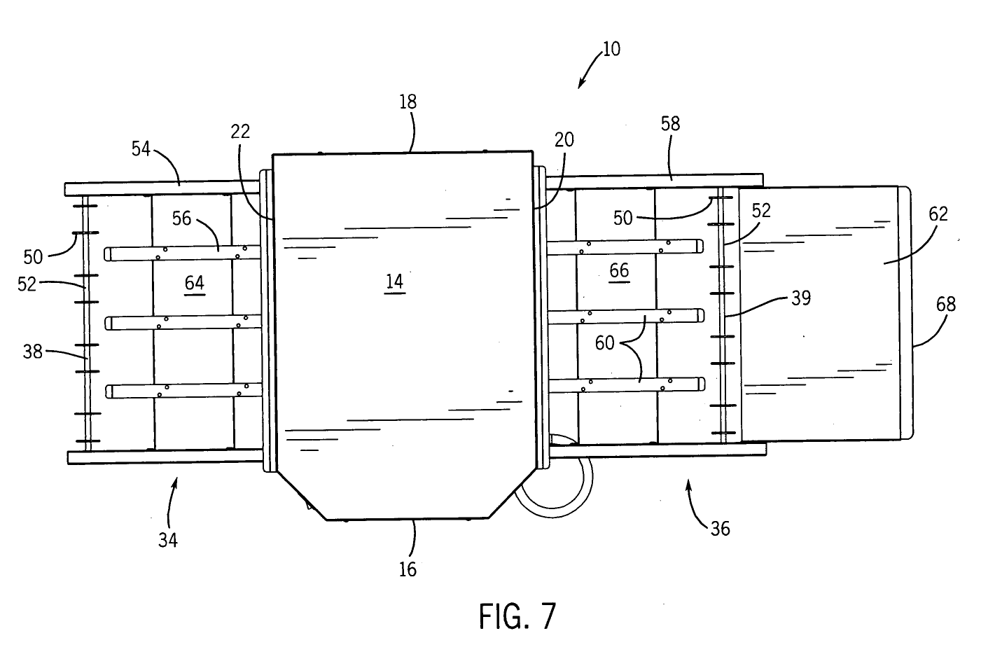

Referring to FIGS. 1-7, a conveyor oven, oven device, heating device, or conveying device 10 is shown according to one embodiment. Although only one embodiment is depicted in FIGS. 1-7, it should be understood that a wide variety of embodiments are contemplated that incorporate one or more of the claimed features. Accordingly, the use of a single embodiment to describe the subject matter disclosed herein should not be considered limiting in any way to the scope of the claims and the general principles described.

The conveyor oven 10 generally comprises an oven housing 11 which is configured to receive a food item to be heated therein, a conveyor assembly 13 which is configured to move the food item through the oven housing 11, and a control unit 15 which is used to control the heating and/or movement of the food item. The oven housing 11 includes a base or lower portion 12, a top or upper portion 14, a front wall or front portion 16, a rear wall or rear portion 18, a right side wall or right side portion 20, and a left side wall or left side portion 22. In this embodiment, the top 14 is coupled to the front portion 16, the rear wall 18, the right side wall 20, and the left side wall 22, all of which extend downwardly from the top 14. The base 12 is coupled to the front wall 16 and the rear wall 18. Between the base 12 and the left side wall 22 is a space or opening 24 through which a food item may pass to enter and/or exit the oven housing 11. A corresponding space or opening 26 is provided between the base 12 and the right side wall 20 through which a food item may pass to enter and/or exit the oven housing 11. The housing and its subcomponents may be made of stainless steel, or, in alternative embodiments, any suitable material (e.g., ceramic, etc.) that can withstand the temperatures and other operating conditions while still meeting food equipment requirements and providing the desired functionality.

Before continuing with the description, it should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The base 12, the right side wall 20, the left side wall 22, the rear wall 18, the front wall 16, and the top 14 define a heating chamber 28. The heating chamber 28 may be heated using a wide variety and number of heating units 31. In the embodiment shown in FIG. 2, the heating unit 31 is positioned above the heating chamber 28. Additional heating units 31 may also be positioned below the heating chamber 28 adjacent the base 12 and/or on any side of the heating chamber 28 such as the right side wall 20, the left side wall 22, the rear wall 18, and/or the front wall 16. The heating unit 31 may be used to heat food items by way of convention, radiation, or conduction. Accordingly, any of a number of suitable configurations may be used.

In one embodiment, the heating unit 31 may comprise one or more heating elements 30 which may be used to heat food items in the oven housing 11. The heating elements 30 may be any suitable apparatus, device, or mechanism that is configured to generate heat. The heating elements 30 may be configured to generate heat using a chemical reaction (e.g., gas burner, etc.), electrical resistance (e.g., resistive heating elements, etc.), etc. In one embodiment, the heating elements 30 may be configured to provide radiant energy to receive a flow of electricity that is converted to heat by the resistance in the heating elements 30.

In one embodiment, the heating elements 30 are resistive heating elements which employ a thin, high-intensity resistive ribbon element which heats up to an orange glow almost instantaneously (e.g., in less than about 1.0 or 0.5 seconds). Conveyor oven 10 is thus able to reach its operating temperature very quickly, which may be desirable in certain settings such as the fast-food industry. In another embodiment, the heating elements 30 are configured to reach an operating temperature within a time period on the order of seconds (e.g., 0 to 10 seconds). In other embodiments, the heating elements 30 may be a resistive wire coil, etc. In one embodiment, the heating elements 30 may be those disclosed in U.S. Pat. Nos. 6,262,396 and 6,384,381, both of which are hereby incorporated by reference in their entirety.

The size and number of the heating elements 30 will depend on the particular food service application, and to a large extent will depend on the sizes and shapes of the plates, trays, or other food support assemblies used. For example, a single heating element 30 may be used for certain smaller scale applications, while in other larger scale applications, multiple heating elements 30 may be used. In one application, conveyor oven 10 may include multiple heating zones each of which use one or more heating elements 30. Other types, sizes, numbers, and geometrical arrangements of the heating elements 30 are possible depending upon the particular conveyor oven application, and the size and shape of the food items and associated food support assemblies. Such alternative conveyor oven configurations will be readily apparent to those of skill in the art.

In one embodiment, the oven housing 11 is configured to include an upper heating unit 31 as shown in FIG. 2, and a lower heating unit 31 (not shown) located in the base 12. Each heating unit 31 may comprise a glass plate, glass member, or glass surface 70 through which radiant heat is transmitted from the heating elements 30. The glass plate 70 may protect the heating elements 30 from damage and/or provide easy clean up of the heating chamber 28. In one embodiment, the glass plate 70 is a ceramic glass having relatively high transmissivity (e.g., 80%, 85%, 90%) and low thermal expansion.

When food items are positioned in the heating chamber 28 between the glass plates 70 from the lower and upper heating units 31, heat generated by the heating elements 30 may be directed or focused toward the food items from both above and/or below the food items. The heat from the lower heating unit 31 performs the dual function of heating the plate or tray which supports the food items and heating the food items themselves, and the heat from the upper heating unit 31 heats the top of the food product.

The oven housing 11 shown in FIGS. 1-7 represents only one embodiment of a suitable housing. For example, in another embodiment, the oven housing 11 may include multiple openings on each side of the housing to cooperate with multiple conveyor assemblies. Other modifications may be made to the oven housing 11 as would be appreciated by one of ordinary skill in the art.

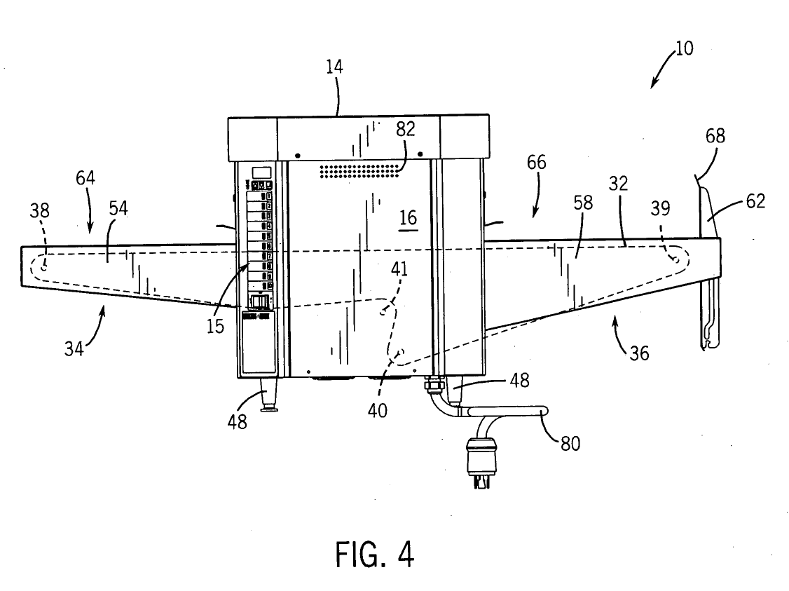

The conveyor assembly 13 includes a conveyor, moving surface, or conveying member 32, a left side support assembly 34, a right side support assembly 36, and a plurality of guide members 38-41 which are used to guide the conveyor 32. In one embodiment; the conveyor 32 is an endless conveyor (e.g., belt, loop, etc.). In one embodiment, the conveyor is a wire belt that has a substantial amount of open space between the wires. In another embodiment, the conveyor may be made of heat resistant materials that are able to withstand the temperatures at which food is cooked. For clarity purposes, in the remainder of this document, the conveyor 32 is referred to as conveyor belt 32. However, the conveyor 32 may also include other configurations, devices, and/or apparatus for conveying the food item through the heating chamber 28 (e.g., a reciprocating surface). Also, for clarity and ease of description purposes, the conveyor belt 32 is only shown in outline form in FIG. 4.

The conveyor 32 may be used to move food items through the heating chamber 28 using indexed movement or continuous movement. In addition to it ordinary meaning, indexed movement generally refers to starting and stopping the movement of the conveyor 32 at least once during the process of moving the food item through the heating chamber 28. In contrast, continuous movement refers to moving the conveyor 32 in one continuous movement. In embodiments where the conveyor utilizes indexed movement, the time that the conveyor is moving and/or the time that the conveyor is stopped may be selectively adjusted using an electronic control unit such as control unit 15.

Referring to FIG. 4, the conveyor belt 32 is configured to be in an S-shape to facilitate movement of the conveyor belt 32 using a motor (not shown). In the embodiment shown in FIGS. 1-7, the motor is contained in a motor housing 44 which includes a plurality of vent holes 46 for providing ventilation to the motor. The motor is used to cooperate with one of the guides members 40, 41 to drive the conveyor belt 32. The S-shaped configuration of the conveyor belt 32 is one way of providing adequate tension in the conveyor belt 32 while at the same time providing suitable driving engagement with the guide member 40, 41 that cooperates with the motor to drive the conveyor belt 32. In other embodiments, the conveyor belt 32 may be configured to be in an oblong shape or other suitable shape.

In general, the guide members 38-41 are positioned in locations where the conveyor belt 32 changes direction. The guide members 38-41 are desirably low friction devices that facilitate the desired movement of the conveyor belt. In the embodiment shown in FIG. 2, the guide members 38-41 comprise a rod 52 and a plurality of rotating members 50. The rotating members 50 are configured to rotate as the conveyor belt 32 passes over them. Some of the rotating members 50 comprise a plurality of teeth which engage the conveyor belt 32 to reduce slippage of the conveyor belt 32 relative to the rotating members 50. In the embodiment where the conveyor belt 32 is a wire belt, the teeth may be configured to engage the holes in between the individual strands of wire that make up the wire belt. In other embodiments, the guide members 38-41 may comprise rollers or any other suitable apparatus, device, or mechanism to guide the conveyor 32.

The left side support assembly 34 includes guide member 38, a frame 54, and support members 56. The frame 54 is coupled to and extends outwardly from the oven housing 11. The support members 56 are used to support the conveyor belt 32 to reduce sagging of the conveyor belt 32. The support members 56 may be especially desirable in situations where the conveyor belt 32 is supporting heavy food items. The support members 56 may be configured to reduce the amount of friction from the conveyor belt 32 passing over the support members 56.

The right side support assembly 36 includes guide member 39, a frame 58, support members 60, and receiving tray 62. In general, the right side support assembly 36 is configured in a similar manner to that of the left side support assembly 34, with the exception of receiving tray 62. Of course, in other embodiments, the rights side support assembly 36 and the left side support assembly 34 may both include or not include a tray 62. The lengths of the support assemblies 34, 36 may also be adjusted so that they are substantially the same or different. For example, in one embodiment it may be desirable to provide a longer support assembly on the side of the conveyor oven 10 which receives the heated food items. Using a longer support assembly may provide additional space where the food items may be received after being heated.

In the embodiment shown in FIGS. 1-7, the let side support assembly 34 is positioned adjacent to or is part of a staging area 64 and the rights side support assembly 36 is positioned adjacent to or is part of a receiving area 66. The staging area 64 is where the food items are placed prior to being heated by the conveyor oven 10. The receiving area 66 is where the food items are positioned after being heated by the conveyor oven 10. Of course, the staging area 64 and the receiving area 66 may be configured to be in a variety of locations which have a number of configurations. For example, in one embodiment, the staging area 64 and the receiving area 66 may be in the same area. This may happen in situations where the conveyor belt 32 moves in one direction to move the food item into the oven housing 11 then reverses direction to move the heated food item out of the oven housing 11. Thus, the same general area is used for staging and receiving the food item.

In operation, a user typically places a food item on conveyor belt 32 in staging area 64 and then removes the food item from the conveyor belt 32 in the receiving area 66. The receiving tray 62 may be used to receiving additional food items in the receiving area 66. The receiving tray 62 may also include a lip 68 which may be used to prevent food items from falling off of the right side support assembly 36. This may be desirable in situations where the user forgets to remove the items after they are heated. In these situations, the food items contact the lip 68 rather than falling off of the support assembly 36. In some situations, the adjacent food items may contact each other and stack up in the receiving area 66 with some of the food items still being on conveyor belt 32. In order to prevent the conveyor belt 32 from pushing the food items off of the support assembly 36, the conveyor belt 32 may be configured to interface with the food item (or the plate or other support device used to hold the food) in a low friction manner so that the conveyor belt 32 can move underneath the food item.

Referring to FIG. 4, the receiving tray 62 may be configured to be selectively adjusted between a substantially upright or vertical position and a horizontal position. The receiving tray 62 may be in the upright position for storage, cleaning, shipping, etc. and be in the horizontal position for use. In another embodiment, the receiving tray 62 may be used in the upright position to provide an even greater barrier to prevent food items from falling off of the right side support assembly 36.

As mentioned above, the movement of the conveyor assembly 13 and the heat output of the heating units 31 may be controlled using the control unit 15. The control unit 15 may be configured to be coupled to the oven housing 11 using fasteners (e.g., screws, rivets, etc.), etc. Control unit 15 includes a user interface or front surface 72 having a number of input devices (e.g., membrane buttons, switches, etc.) which allow the user to input operating information into the control unit 15 and a number of output devices (e.g., LCD screen, LEDs, etc.) to display status information to the user. The operating information may be used to control the operation of heating unit 31 and/or the conveyor assembly 13. Control unit 15 may include an electronic controller/output circuit board (not shown) which interfaces with the user interface 72. The user interface 72 is coupled to the oven housing 11 in such a manner that the input devices are accessible to the user and the output devices are visible to the user.

In one embodiment, the control unit 15 may be configured to provide programmable control of the heating units 31 and the conveyor assembly 13, and, in particular, the conveyor belt 32, using timer circuits and/or a microprocessor-based controller. In one embodiment, the control unit 15 may provide the user with a plurality of operating programs or sequences for controlling the conveyor assembly 13 and/or the heating units 31 with a corresponding plurality of push-buttons 74 provided to allow for one-touch control for each operating program. In the embodiment shown in FIGS. 1-4, the control unit 15 includes ten push-buttons 74 which correspond to ten different operating programs, however, it should be understood that more or less than ten buttons 74 may also be provided (e.g., two buttons, 25 buttons). In another embodiment, the user may select the operating program using a menu displayed on a screen. A number of other suitable ways may be used to input and select the desired operating program.

Each operating program may be programmed for a different type of food item, thereby allowing the food service user to select one of the plurality of predetermined programs simply by pushing one of buttons 74. For example, the conveyor oven 10 may be configured or programmed such that one push-button 74 triggers a first preset program for operating the heating elements 30 (e.g., upper and lower heating elements) and the conveyor belt 32 in a first manner suitable for heating hamburgers, a second push-button triggers a second program for operating the heating elements 30 in a second manner suitable for heating hot dogs, etc. In this way, the conveyor oven 10 can be programmed to provide a simple user interface allowing even users with little experience and training to accurately control the heating of many food items. In addition, a food item may be placed in the staging area 64 and an operating program selected even though a food item is already in the heating chamber 28. Once the food item in the heating chamber 28 has finished heating, the food item in the staging area 64 may be automatically moved to the heating chamber 28 where the previously selected operating program is used to control heating of the food item.

The control unit 15 may be used to control the heat output of the heating elements 30 and the movement of the conveyor belt 32 in a number of ways. In one embodiment, the control unit 15 controls the conveyor belt 32 by controlling the power provided to the motor which drives the conveyor belt 32. In another embodiment, the control unit 15 controls the heat output of the heating elements 30 by controlling the power provided to the heating elements 30. In situations where there are multiple heating elements 30 (e.g., upper and lower heating elements) and/or multiple conveyor belts 32, the control unit 15 may be configured to control each one independently of the others. For example, in one embodiment, the heating time (i.e., time the heating element 30 is on) and/or power level of one heating element 30 may be adjusted independently of the heating time and/or power level of the other heating elements 30. This may provide a greater amount of flexibility in customizing the operating programs to the various food items that are heated. Accordingly, each operating program may be configured to include operating parameters which are related to the movement of the conveyor belt 32 and/or the heat output of the heating elements 30.

In one embodiment, the movement of the conveyor belt 32 is controlled by activating and deactivating the motor which drives the conveyor belt 32. By selectively activating and deactivating the motor, the control unit 15 may move the conveyor belt 32 using indexed movement. The time that the motor is activated and/or deactivated may be input by the user using user interface 72. In this example, the control unit 15 may control the movement of the conveyor belt 32 without the use of sensors and other devices that are associated with feedback control that may otherwise be prone to failure over long periods of time.

In other embodiments, a greater degree of control may be desired than simply turning the motor on and off for predetermined amounts of time. In these embodiments, the control unit 15 may be configured to control the conveyor belt 32 using a sensor which senses the movement (e.g., speed, distance, etc.) of the conveyor belt 32. These embodiments may also provide the conveyor belt 32 with indexed movement and/or variable speed movement. For example, the control unit 15 may use pulse-width modulation (PWM) to control the speed of the conveyor belt 32.

Likewise, the heating elements 30 may also be controlled in similar fashion. For example, the control unit 15 may be configured to selectively activate and deactivate the heating elements 30 to provide a certain heat output. The user may be able to selectively adjust the heat output of the various heating elements 30 in the conveyor oven 10 by specifying a power level or other operating parameter (e.g., activation times, etc.) relating to the heat output of the heating elements 30 using the user interface 72. In one embodiment, the power level may be adjustable from 5% to 100% in increments of about 1%, or about 5%, etc. A power level of 100% may be considered the level at which full uninterrupted power is provided to the heating elements 30 and 0% power is where no power is provided to the heating elements 30. To provide the desired power level, the control unit 15 may pulse the power provided to the heating elements 30 at a desired rate. In one embodiment, the rate at which the power is pulsed to the heating elements 30 directly corresponds to the selected power level (e.g., heating elements are pulsed on 30% of the time to provide a 30% power level). In another embodiment, PWM may be used to provide the desired power level.

In another embodiment, the control unit 15 may be coupled to a plurality of sensors (e.g., thermocouples) which are used to detect the temperature in the heating chamber 28. The power provided to the heating elements 30 may be controlled based on the temperature sensed in the heating chamber 28.

In one embodiment, the control unit 15 is configured to control the movement of the conveyor belt 32 to provide the conveyor belt 32 with indexed movement. For example, a user may place a food item on the conveyor belt 32 of the staging area 64 and press the appropriate button 74 to heat the food item. Under the control of the control unit 15, the conveyor belt 32 moves the food item into the heating chamber 28 and stops. After the food item is heated according the operating parameters provided in the operating program, the conveyor belt 32 is activated and moves the food item out of the heating chamber 28 and to the receiving area 66.

In another embodiment, the control unit 15 may be configured to provide indexed movement that approximates continuous movement. For example, the control unit 15 may be used to repeatedly activate and deactivate the motor to provide indexed or stepwise movement of the conveyor belt 32. In one embodiment, the user may selectively adjust the time the motor is activated and/or the time the motor is deactivated. In one embodiment, the control unit 15 may be configured to activate the motor for 0.5 second then deactivate the motor for a time that is selectively adjustable by the user (e.g., anywhere from 0-60 seconds in 0.1 or 0.5 second increments). Thus, if the user chooses the deactivation time to be 0 seconds, then the conveyor belt 32 runs continuously. If the user chooses the deactivation time to be 2 seconds then the conveyor belt 32 runs for 0.5 second and stops for 2 seconds repeatedly until the food item is received in the receiving area 66. In another embodiment, the user may be able to select the time that the motor is activated and/or deactivated. For example, the user may be able to select anywhere from 0 to 60 seconds in increments of 0.1 to 5 seconds for either or both the time that the motor is activated (e.g., the time the conveyor belt 32 is moving) and the time that the motor is deactivated (e.g., the time that the conveyor betl 32 is stationary). The control unit 15 may be configured to recognize that the operating program has been completed because the control unit 15 is programmed with information about how much total time the motor should be on for the food item to reach the receiving area 66. Once the motor has been turned on for this total period of time (e.g., 0.5 seconds multiplied by the number of times the motor has been turned on) then the operating program is complete.

In another embodiment, the control unit 15 may be used to move the food item into the heating chamber 28 by sensing the distance that the conveyor belt 32 has traveled. Once the conveyor belt 32 has traveled the distance to the heating chamber 28 then the conveyor belt 32 stops to allow the food item to be heated.

Using indexed movement of the conveyor belt 32 may provide a number of advantages. For example, unlike conventional conveyor ovens, the heating chamber 28 only needs to be as large as the largest item that is cooked. Thus, a substantial amount of space may be saved. Also, the conveyor oven 10 can be easily customized by the user to heat adjacent food items at different conditions such as heating time. For example, one food item may need to be heated at a high temperature for a short period of time while another food item may need to be heated at a lower temperature for a longer period of time. In conveyor oven 10, heating different food items in different conditions is straightforward since the heating time may be adjusted by adjusting the time that the conveyor belt 32 is deactivated when the food item is positioned adjacent to the heating chamber 28 and the heating elements 30 may be quickly changed from one heat output level to another.

The use of the rapidly-heating heating elements 30 may also allow the heating elements 30 to be in a stand-by mode or orientation when there are no food items ready to be heated. In stand-by orientation, the heating elements 30 may be turned off or may be at a substantially reduced power level. The conveyor oven 10 may still be available for on-demand use by the user. Once the user places a food item on the staging area 64 and then selects an operating program, then the heating elements 30 rapidly heat up to an operating temperature. By being on stand-by when not currently being used, but still being available for on-demand use, the conveyor oven 10 may be more energy efficient than conveyor ovens where the heating elements remain on continuously. In a further embodiment, the heating elements 30 may be in the stand-by orientation during the time that one food product is being moved from the heating chamber 28 to the receiving area 66 and another food item is being moved from the staging area 64 to a position adjacent to the heating chamber 28.

The control unit 15 may be used to indicate to the user the status of the food item. For example, when a food item has been heated and positioned in the receiving area 66, the user interface 72 may be used to notify the user by way of audio (e.g., beep or specified beep sequence) and/or visual (e.g., LEDs that light up and/or flash) that the food item is ready to be removed from the conveyor oven 10. In another embodiment, audio and visual indicators may be used to show the amount of time left for a particular item to be heated (e.g., displays a percentage done or bar graph that shows how long the food item has been heated in relation to how long it remains to be heated, etc.).

The conveyor oven 10 may be any suitable size for use in a wide variety of situations. In one embodiment, the conveyor oven 10 is sized to be positioned on a countertop. In another embodiment, the conveyor oven 10 is sized to be positioned on a floor. Supports or legs 48 may be used to securely position the conveyor oven 10 on the countertop, floor or other surface. To this end, the supports 48 may include a high friction rubber coating which prevents sliding movement of the conveyor oven 10 relative to the surface. In another embodiment, the supports 48 may be adjustable to account for surfaces that may be uneven. In other embodiments, the conveyor oven 10 may be integrally built into the structure of a building without the use of supports 48.

An electrical power cord 80 passes through a grommet 84 into the interior of the oven housing 11 to provide electrical energy to run the conveyor oven 10. To provide a cooling air flow to the interior components of the conveyor oven 10, a vent 82 in the oven housing 11 may be provided. Optionally, a cooling fan may also be provided to circulate air through the vent 82.

As used herein, spatial or directional terms, such as “left”, “right”, “front”, “back”, and the like, relate to the description of the subject matter as it is shown in the drawing figures. However, it is to be understood that the subject matter described herein may assume various alternative orientations and, accordingly, such terms are not to be considered as limiting. Also, as used herein, articles such as “the,” “a,” and “an” can connote the singular or plural. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

1. A conveyor oven comprising:
a heating chamber which receives a food item to be heated;
a conveyor which moves the food item through the heating chamber using indexed movement; and
a motor which is used to drive the conveyor.

2. The conveyor oven according to claim 1 wherein the conveyor comprises a conveyor belt.

3. The conveyor oven according to claim 1 wherein the conveyor moves the food item to a stationary position in the heating chamber to heat at least a portion of the food item and moves the food item to another position away from the heating chamber once at least the portion of the food item has been heated.

4. The conveyor oven according to claim 1 wherein the indexed movement of the conveyor is provided by activating and deactivating the motor.

5. The conveyor oven according to claim 4 wherein the indexed movement of the conveyor is provided by repeatedly activating and deactivating the motor.

6. The conveyor oven according to claim 1 wherein the indexed movement is provided by repeatedly starting and stopping the movement of the conveyor as it moves the food item through the heating chamber.

7. The conveyor oven according to claim 6 wherein at least one of the time the conveyor is in motion or the time the conveyor is stopped is selectively adjustable by a user.

8. The conveyor oven according to claim 1 wherein the movement of the conveyor is controlled based on input received from a user.

9. The conveyor oven according to claim 1 comprising a heating element positioned in the heating chamber, the heat output of the heating element being controlled based on input received from a user.

10. The conveyor oven according to claim 1 comprising an electronic control unit which stores a plurality of operating programs each of which includes at least one operating parameter which is related to at least one of movement of the conveyor or heat output of a heating element in the heating chamber.

11. The conveyor oven according to claim 10 wherein the at least one operating parameter relates to the indexed movement of the conveyor.

12. The conveyor oven according to claim 1 comprising a heating element used to heat the food in the heating chamber, the heating element being capable of being heated to an operating temperature within a time period on the order of seconds.

13. The conveyor oven according to claim 1 comprising an upper heating element positioned above the heating chamber and a lower heating element positioned below the heating chamber.

14. The conveyor oven according to claim 13 comprising an electronic control unit which is used to control at least one of the time that of the upper and lower heating elements are activated or the power level of each of the upper and lower heating elements.

15. A conveyor oven comprising:
a heating chamber which receives a food item to be heated;
a conveyor which is used to move the food item to a stationary position adjacent to or in the heating chamber; and
a motor which is used to drive the conveyor.

16. The conveyor oven according to claim 15 wherein the conveyor comprises a conveyor belt.

17. The conveyor oven according to claim 15 wherein the food item is in the stationary position for a time that is selectively adjustable by a user.

18. The conveyor oven according to claim 17 comprising a heating element positioned in the heating chamber, a heat output of the heat element being controlled based on input received from a user.

19. The conveyor oven according to claim 15 comprising an electronic control unit which stores a plurality of operating programs corresponding to a plurality of food items, the operating programs including at least one operating parameter which is related to at least one of movement of the conveyor or heat output in the heating chamber.

20. The conveyor oven according to claim 15 comprising a heating element used to heat the food in the heating chamber the heating element being capable of being heated to an operating temperature within a time period on the order of seconds.

21. The conveyor oven according to claim 15 comprising a staging area where the food item is received by the conveyor and a receiving area where the food item is received after the food item has been heated in the heating chamber, wherein the conveyor moves the food item from the staging area to the stationary position in the heating chamber to heat the food item and moves the food item from the stationary position to the receiving area after the food item has been heated.

22. A conveyor oven comprising:
a heating chamber which receives a food item to be heated; and
a conveyor belt which moves the food item through the heating chamber, the conveyor belt being configured to stop at least while the food item is being heated.

23. The conveyor oven according to claim 22 wherein the conveyor belt is repeatedly moved and stopped while the food item is being heated.

24. The conveyor oven according to claim 22 wherein the movement of the conveyor is controlled based on input received from a user.

25. The conveyor oven according to claim 22 comprising a heating element positioned in the heating chamber, the heat output of the heating element being controlled based on input received from a user.

26. The conveyor oven according to claim 22 wherein the time that the conveyor belt is stopped is adjustable by a user.

27. The conveyor oven according to claim 22 comprising an electronic control unit which stores a plurality of operating programs each of which includes at least one operating parameter which is related to at least one of movement of the conveyor or heat output of a heating element in the heating chamber.

28. The conveyor oven according to claim 22 comprising a heating element used to heat the food in the heating chamber, the heating element being capable of being heated to an operating temperature within a time period on the order of seconds.

29. A conveyor oven comprising:
a heating chamber which receives a food item to be heated; and
an endless conveying member which moves the food item through the heating chamber using indexed movement.

30. The conveyor oven according to claim 29 wherein the indexed movement of the conveyor member is provided by activating and deactivating a motor which is used to drive the conveyor.

31. The conveyor oven according to claim 29 wherein the movement of the conveyor member is controlled based on input received from a user.

32. The conveyor oven according to claim 29 comprising an electronic control unit which stores a plurality of operating programs each of which includes at least one operating parameter which is related to at least one of movement of the conveyor member or heat output of a heating element in the heating chamber.

33. The conveyor oven according to claim 29 comprising a heating element used to heat the food in the heating chamber, the heating element being capable of being heated to an operating temperature within a time period on the order of seconds.

34. A conveyor oven comprising:
a heating chamber which receives a food item to be heated; and
a conveyor which moves the food item through the heating chamber, the conveyor being selectively adjustable between a continuous movement orientation and an indexed movement orientation.

35. The conveyor oven according to claim 34 wherein the conveyor comprises a conveyor belt.

36. The conveyor oven according to claim 34 wherein the indexed movement of the conveyor includes repeatedly starting and stopping the movement of the conveyor as it moves the food item through the heating chamber.

37. The conveyor oven according to claim 34 wherein the speed of the conveyor in the continuous movement orientation is adjustable.

38. The conveyor oven according to claim 34 comprising a heating element positioned in the heating chamber, the heat output of the heating element being adjustable.

39. A conveyor oven comprising:
a heating chamber which receives a food item to be heated; and
a conveyor which moves the food item through the heating chamber;
wherein the heating chamber includes a rapidly-heating heating element which is capable of being cycled between a heating orientation when the food item is received in the heating chamber and a standby orientation when the heating chamber is not being used to heat the food item.

40. The conveyor oven according to claim 39 wherein the heating element used to heat the food is capable of being heated to an operating temperature within a time period on the order of seconds.

41. The conveyor oven according to claim 39 wherein the heating element provides radiant energy directly to the food item.

42. The conveyor oven according to claim 41 comprising a glass member that allows transmission of the radiant energy from the heating element to the food item.

43. The conveyor oven according to claim 39 wherein the heating element is a resistive ribbon heating element.

44. The conveyor oven according to claim 39 wherein the conveyor moves the food item using indexed movement.

45. A conveyor oven comprising:
a heating chamber which receives a food item to be heated; and
a conveyor which moves the food item through the heating chamber;
wherein the heating chamber includes a rapidly-heating heating element to provide substantially on-demand use of the heating chamber to heat the food item.

46. The conveyor oven according to claim 45 wherein the heating element used to heat the food is capable of being heated to an operating temperature within a time period on the order of seconds.

47. The conveyor oven according to claim 45 wherein the heating element provides radiant energy directly to the food item.

48. The conveyor oven according to claim 47 comprising a glass member that allows transmission of the radiant energy from the heating element to the food item.

49. The conveyor oven according to claim 45 wherein the heating element is a resistive ribbon heating element.

50. The conveyor oven according to claim 45 wherein the conveyor moves the food item using indexed movement.

51. A method for heating a food item comprising:
moving at least a portion of a food item into a heating chamber using a conveyor belt;
stopping the movement of the conveyor belt while at least the portion of the food item is heated in the heating chamber;
moving the food item away from the heating chamber once the food item has been heated.

52. The method for heating a food item according to claim 51 wherein the conveyor belt is stopped for a period of time that is adjustable by a user.

53. The method for heating a food item according to claim 51 comprising receiving input from a user, the input including selecting one of a plurality of operating programs each of which include at least one parameter related to stopping the movement of the conveyor belt.
